(19) United States
(12) Patent Application Publication
(10) Pub. No.: US 2022/0027818 A1
(43) Pub. Date: Jan. 27, 2022

(54) INFORMATION PROCESSING APPARATUS, INFORMATION PROCESSING METHOD AND NON-TRANSITORY STORAGE MEDIUM

(71) Applicant: Toyota Jidosha Kabushiki Kaisha, Toyota-shi Aichi-ken (JP)

(72) Inventor: Xin Jin, Nagoya-shi (JP)

(21) Appl. No.: 17/370,573

(22) Filed: Jul. 8, 2021

(30) Foreign Application Priority Data
Jul. 22, 2020 (JP) 2020-125738

(51) Int. Cl. G06Q 10/06; G06Q 10/02; G06Q 30/02

(52) U.S. Cl. CPC G06Q 10/06314; G06Q 30/0284; G06Q 10/02; G06Q 10/06315

(57) ABSTRACT

The present disclosure enables determining a proper operation schedule of vehicles in a traffic system in which a plurality of users rides in a same vehicle. The present disclosure provides an information processing apparatus for determining an operation schedule of a vehicle for a plurality of users to share a ride in. A controller in an information processing apparatus executes first processing of acquiring one or more ride requests including a desired boarding time from each of one or more users wishing to board the vehicle at a predetermined boarding spot. The controller executes second processing of grouping the one or more ride requests to create one or more groups and determining an arrival time of the vehicle at the boarding spot for each of the created groups.

### CROSS-REFERENCE TO THE RELATED APPLICATION

This application claims priority to Japanese Patent Application No. 2020-125738, filed on Jul. 22, 2020, which is hereby incorporated by reference in its entirety.

### BACKGROUND

### Technical Field

The present disclosure relates to a technique for a plurality of users to travel by sharing a ride in a same vehicle.

### Description of the Related Art

For purposes such as traffic jam alleviation, fuel cost saving and environmental protection, a form of traveling with a plurality of users sharing a ride in a single vehicle (ride-sharing) has been spreading mainly in foreign countries.

In this connection, for example, Japanese Patent Laid-Open No. 2003-308596 discloses a system in which a ride-sharing vehicle is dispatched based on ride requests acquired from a plurality of users.

In a case of a small amount of transportation, a vehicle can be dispatched each time on demands for efficient transportation in comparison with a regular bus or the like including a fixed operation schedule.

[Patent document 1] Japanese Patent Laid-Open No. 2003-308596.

### SUMMARY

In a case where vehicles are dispatched based on requests transmitted from users, a problem is that a large number of vehicles are needed to individually respond to all of the requests.

One or more aspects of the present disclosure, which has been made in consideration of the above problem, are directed to determine a proper operation schedule of vehicles in a traffic system in which a plurality of users rides in a same vehicle.

One aspect of an information processing apparatus according to a first aspect of the present disclosure may be an information processing apparatus for determining an operation schedule of a vehicle for a plurality of users to share a ride in, the information processing apparatus including a controller including at least one processor configured to execute: first processing of acquiring one or more ride requests including a desired boarding time from each of one or more users wishing to board the vehicle at a predetermined boarding spot; and second processing of grouping the one or more ride requests to create one or more groups and determining an arrival time of the vehicle at the boarding spot for each of the created groups.

Also, an information processing method according to a second aspect of the present disclosure may be an information processing method executed by an information processing apparatus, the information processing apparatus determining an operation schedule of a vehicle for a plurality of users to share a ride in, the information processing method including: acquiring one or more ride requests including a desired boarding time from each of one or more users wishing to board the vehicle at a predetermined boarding spot; and grouping the one or more ride requests to create one or more groups and determining an arrival time of the vehicle at the boarding spot for each of the created groups.

Also, a third aspect of the present disclosure may provide a computer-readable storage medium non-transitorily storing a program for making a computer execute the above-stated information processing method.

The present disclosure enables determining a proper operation schedule of vehicles in a traffic system in which a plurality of users rides in a same vehicle.

### BRIEF DESCRIPTION OF THE DRAWINGS

FIG. 1 is a schematic configuration diagram of a traffic system according to a first embodiment;

FIGS. 2A to 2C are diagrams illustrating a relationship between desired boarding times and arrival time(s);

FIG. 3 is a system configuration diagram of a user terminal 10 according to the first embodiment;

FIG. 4 is a diagram illustrating ride requests;

FIG. 5 is a system configuration diagram of a server apparatus 20 according to the first embodiment;

FIG. 6 is a flowchart of processing performed by the server apparatus in the first embodiment;

FIG. 7 is a diagram illustrating an operation schedule created by the server apparatus;

FIG. 8 is a flowchart of processing performed in step S12; and

FIG. 9 is a flowchart of processing performed by a server apparatus in a second embodiment.

### DETAILED DESCRIPTION

The information processing apparatus according to the first aspect of the present disclosure may be an apparatus for, based on ride requests from a plurality of users, determining an operation schedule of a vehicle for the users to ride in (more specifically, an on-demand bus that travels on a predetermined route). Each ride request includes, for example, a spot for the relevant user to board a vehicle (stop) and a desired boarding time.

In a traffic system in which vehicles operate in response to ride requests from users, a problem is that individually responding to all the requests from the users causes a decrease in transportation efficiency.

For example, where three users wish to board a vehicle at a certain stop and respective desired boarding times of the users are shifted relative to one another by 15 minutes, three vehicles need to operate. However, when the respective desired boarding times are adjusted to include the three users board at a same time, only one vehicle needs to operate.

Therefore, the information processing apparatus according to the first aspect of the present disclosure may acquire one or more ride requests including a desired boarding time from each of one or more users wishing to board the vehicle at a predetermined boarding spot and groups the one or more ride requests to create one or more groups and determining an arrival time of the vehicle at the boarding spot for each of the created groups.

In this way, a plurality of ride requests may be grouped for each boarding spot and an arrival time of a vehicle is determined for each group, enabling a plurality of users who has transmitted ride requests individually to board a vehicle at one time and thus enabling enhancement in transportation efficiency.

Also, the controller may group the ride requests based on a density of the desired boarding times relative to a time axis.

For example, a group may preferentially be created for a part in which desired boarding times are more densely located on a time axis. Such processing can be performed by, for example, a density-based clustering method.

Also, the controller may determine the arrival time for each group in such a manner that a difference between the desired boarding time and the arrival time is equal to or below a predetermined value for all of the users.

The above configuration enables curbing a cost imposed on the user side (typically, waiting time).

Also, the controller may calculate a weighted average of the desired boarding times using number of the users for each of the created groups, and based on a result of the calculation, determine the arrival times for the respective groups.

For example, a weighted average is calculated in such a manner that as the number of users whose desired boarding times are the same (or substantially the same) is larger, the relevant time is weighted more. Consequently, the cost imposed on the user side can be curbed as a whole.

Also, for each of the created groups, the controller may calculate a fare of the vehicle for the relevant users based on number of the ride requests included in the group.

An increase in number of times of a vehicle picking up a user increases a time or monetary cost. Therefore, the fare is varied based on the number of ride requests included in a group, enabling absorption of the cost increase.

Also, for each of the created groups, the controller may make the fare for the relevant users lower as the number of the ride requests included in the group is larger.

As the number of ride requests included in a group is larger, a larger number of users can board a vehicle at one time. In other words, vehicles can efficiently be dispatched, enabling setting a fare to be low for the relevant users.

Also, after completion of the grouping, the controller may present the calculated fares to the users and finalize reservations.

Executing a phase of confirming a fare enables enhancement in usability.

Also, when there are joinable groups already created at a phase of acquisition of the ride requests from the users, the controller may make the users select which group to join (or select whether or not to create a new group).

Also, the controller may make the users make the selection after calculating the fare for each group and presenting the fares to the users.

When there has already been a plurality of groups, it is possible to make the users select which group to join. In such case, presenting fares enables providing options, a “group that is low in fare but needs the users to wait” and a “group that is high in fare but enable the users to board a vehicle immediately” to the users. Also, creating a new group for the users enables providing a “group that is high in fare but enables the users to board a vehicle at a desired time”.

Specific embodiments of the present disclosure will be described below with reference to the drawings. Hardware configurations, module configurations, functional configurations, etc., described in the embodiments are not intended to limit the technical scope of the disclosure only thereto unless specifically noted otherwise.

### First Embodiment

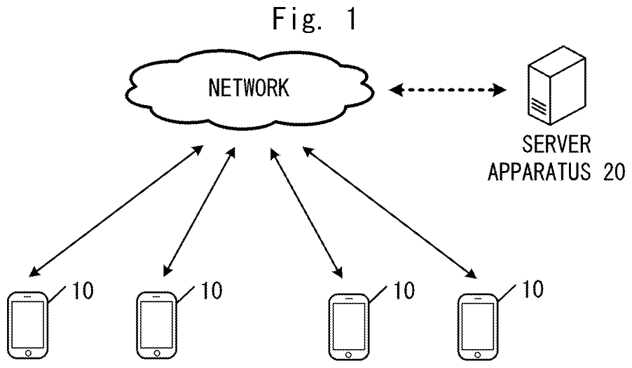

FIG. 1 illustrates an overview of a traffic system according to a first embodiment. The traffic system according to the present embodiment includes user terminals 10 associated with users who board on-demand buses and a server apparatus 20 that manages operations of the on-demand buses.

An on-demand bus (hereinafter, simply referred to as “vehicle”) is a transportation facility whose service route and boarding/alighting spots (stops) are fixed in advance and operates as needed in response to ride requests from users.

Each user wishing to ride in a vehicle transmits a ride request to the server apparatus 20 via the relevant user terminal 10. The ride request includes, for example, a boarding spot (boarding stop), a desired boarding time and an alighting spot (alighting stop).

These information pieces are generated and transmitted, for example, using application software for using the traffic system, which is installed in the user terminal 10. However, these information pieces may not necessarily be generated using a mobile terminal. For example, these may be generated using any terminal connectable to a network (e.g., a smartphone, a mobile phone, a tablet terminal, a personal information terminal or a wearable computer) or a personal computer.

The server apparatus 20 collects the ride requests from the user terminals 10 and creates an operation schedule of vehicles. The operation schedule includes, for example, arrival times for a plurality of stops on the relevant service route and the number of users who board at each stop.

In the traffic system according to the present embodiment, the plurality of user terminals 10 and the server apparatus 20 are connected to each other via a network. For the network, for example, a WAN (wide area network), which is a worldwide public communication network such as the Internet, or any of other communication networks may be employed. Also, the network may include a telephone communication network for, e.g., mobile phones or a radio communication network such as Wi-Fi (registered trademark).

Upon reception of a plurality of requests for wishing to board a vehicle at a same stop, the server apparatus 20 in the present embodiment groups the ride requests to reduce an operation cost.

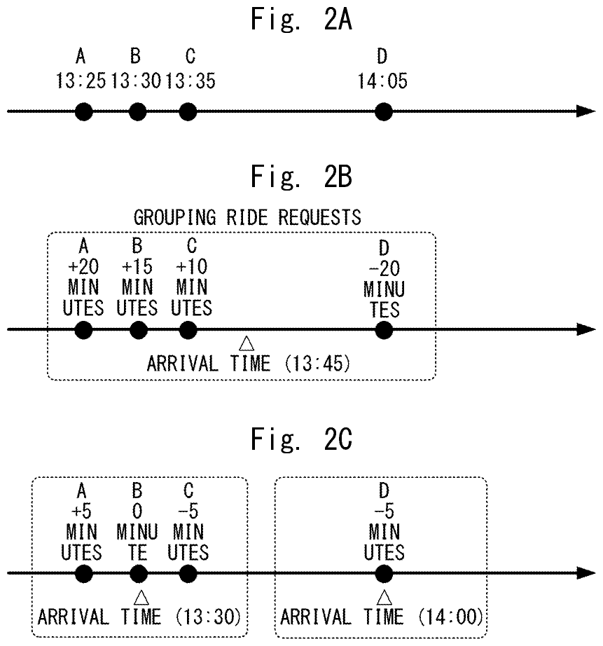

FIGS. 2A, 2B and 2C are diagrams illustrating a relationship between a plurality of ride requests and boarding time(s).

Here, it is assumed that there are four users wishing to board a vehicle at a certain stop. For example, as illustrated in FIG. 2A, it is assumed that respective desired boarding times are dispersed between 13:25 and 14:05. In this case, four vehicles are needed to respond to all of the requests. On the other hand, when the four users board a vehicle at a same time by grouping the plurality of ride requests as in FIG. 2B, only one vehicle needs to operate.

On the other hand, grouping a plurality of ride requests decreases a cost for operation of vehicles but causes a problem of an increase of a cost borne by users. For example, as illustrated in the figure, when four ride requests are grouped to make a vehicle arrive at 13:45, a difference of a maximum of 20 minutes occurs between a desired boarding time and the actual boarding time. When such time differences often occur, convenience of the traffic facility decreases, which may result in disenchantment of users.

In the present example, as a method for reducing the cost borne by the users, for example, there is a method in which the plurality of ride requests is divided into two groups and two vehicles are dispatched as in FIG. 2C. In this way, changing the method of grouping ride requests enables balancing the vehicle operation cost and the cost borne by users.

The server apparatus 20 according to the present embodiment solves the aforementioned problem by performing proper grouping processing using a predetermined criterion.

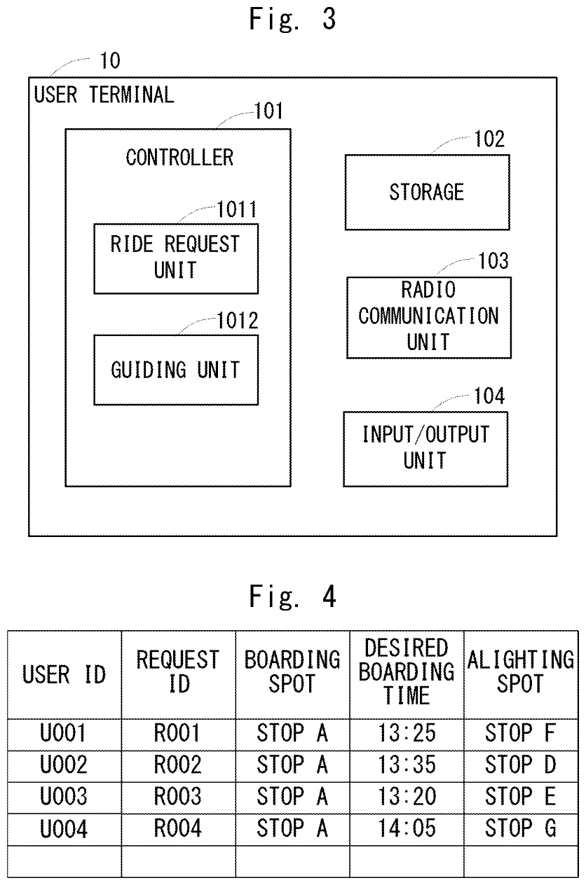

Next, a configuration of the user terminals 10 will be described. FIG. 3 is a system configuration of a user terminal 10.

The user terminal 10 is, for example, a small computer such as a smartphone, a mobile phone, a tablet computer, a personal information terminal, a notebook computer or a wearable computer (e.g., a smartwatch). The user terminal 10 includes a controller 101, a storage 102, a radio communication unit 103 and an input/output unit 104.

The controller 101 is an arithmetic device that manages control performed by the user terminal 10. The controller 101 can be implemented by an arithmetic processing device such as a CPU (central processing unit).

The controller 101 includes two types of functional modules, a ride request unit 1011 and a guiding unit 1012. Each functional module may be implemented by execution of a program stored in the later-described storage 102 by the CPU.

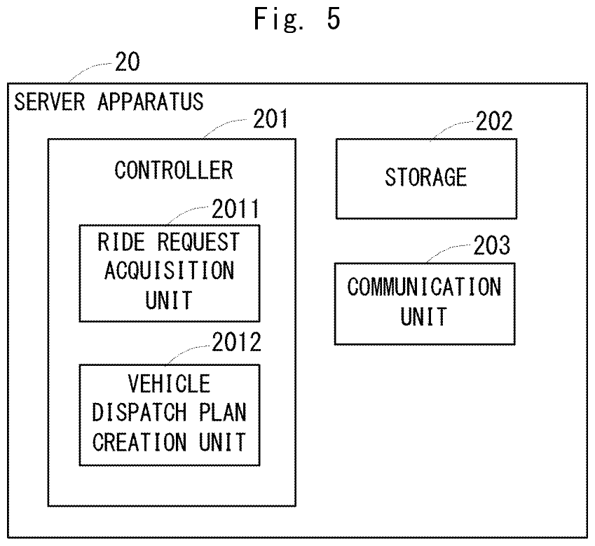

The ride request unit 1011 acquires a request for a vehicle ride reservation from a user and transmits the request to the server apparatus 20. More specifically, the ride request unit 1011 acquires, e.g., a user ID, a boarding spot (boarding stop), a desired boarding time and an alighting spot (alighting stop) via the later-described input/output unit 104. The acquired information is transmitted to the server apparatus 20 as a ride request. FIG. 4 illustrates examples of generated ride requests. Also, the ride request unit 1011 performs processing of finalizing the ride reservation through communication with the server apparatus 20.

After the finalization of the ride reservation, the guiding unit 1012 provides information on operation of a vehicle (hereinafter, “operation information”), the information being transmitted from the server apparatus 20, to the user. The operation information is that generated by the server apparatus 20 based on a plurality of ride requests and include, e.g., an arrival time for a stop.

The storage 102 includes a main memory and an auxiliary memory. The main memory is a memory onto which programs to be executed by the controller 101 and data to be used by such control programs are loaded. The auxiliary memory is a device that stores programs to be executed by the controller 101 and data to be used by such control programs. The auxiliary memory may store those resulting from packaging the programs to be executed by the controller 101 as applications. Also, the auxiliary memory may store an operating system for executing these applications. The below-described processing is performed by programs stored on the auxiliary memory being loaded onto the main memory and executed by the controller 101.

The main memory may include a RAM (random-access memory) and a ROM (read-only memory). Also, the auxiliary memory may include an EPROM (erasable programmable ROM) and a hard disk drive (HDD). The auxiliary memory may further include a removable medium, that is, a removable recording medium. The removable medium is, for example, a USB (universal serial bus) memory or a disk recording medium such as a CD (compact disc) or a DVD (digital versatile disc).

The radio communication unit 103 is a radio communication interface for connecting the user terminal 10 to the network. The radio communication unit 103 provides access to the network via, for example, a wireless LAN or a mobile communication service such as 3G or LTE.

The input/output unit 104 is a unit that receives an operation input made by the user and presents information to the user. In the present embodiment, the input/output unit 104 includes a single touch panel display. In other words, the input/output unit 104 includes a liquid-crystal display and a control unit for the liquid-crystal display and a touch panel and a control unit for the touch panel.

Note that the configuration illustrated in FIG. 3 is a mere example and each of all or some of the functions illustrated in the figure may be implemented by a circuit designed only for the function. Also, programs may be stored and executed by a combination of main memory and an auxiliary memory other than that illustrated in the figure.

Next, a configuration of the server apparatus 20 will be described.

The server apparatus 20 can be configured by a general-purpose computer. In other words, the server apparatus 20 can be configured as a computer including a processor such as a CPU or a GPU, a main memory such as a RAM and/or a ROM, and an auxiliary memory such as an EPROM, a hard disk drive and/or a removable medium. The removable medium may be, for example, a USB memory or a disk recording medium such as a CD or a DVD. In the auxiliary memory, an operating system (OS), various programs, various tables, etc., are stored and respective functions meeting predetermined purposes, such as those described later, are implemented by execution of the programs stored on the auxiliary memory. However, some or all of the functions may be implemented by a hardware circuit such as an ASIC or an FPGA. Note that the server apparatus 20 may be configured by a single computer or may be configured by a plurality of computers linked to each other.

FIG. 5 is a diagram illustrating a system configuration of the server apparatus 20. The server apparatus 20 includes a controller 201, a storage 202 and a communication unit 203.

The controller 201 is a device that manages control performed by the server apparatus 20. The controller 201 can be implemented by an arithmetic processing device such as a CPU.

The controller 201 includes two types of functional modules, a ride request acquisition unit 2011 and a vehicle dispatch plan creation unit 2012. Each functional module may be implemented by a program stored on the auxiliary memory by the CPU.

The ride request acquisition unit 2011 acquires ride requests from the plurality of user terminals 10 and temporarily store the ride requests in the storage 202. The acquired and stored ride requests are used by the vehicle dispatch plan creation unit 2012.

The vehicle dispatch plan creation unit 2012 creates an operation schedule of vehicles based on the plurality of ride requests collected. More specifically, the vehicle dispatch plan creation unit 2012 executes processing of grouping a plurality of ride requests whose desired boarding times are close to each other for each boarding spot (stop) and processing of creating an operation schedule of vehicles based on a result of the grouping. Detailed processing will be described later.

The storage 202 includes a main memory and an auxiliary memory. The main memory is a memory onto which programs to be executed by the controller 201 and data to be used by the control programs are loaded. The auxiliary memory is a device that stores the programs to be executed by the controller 201 and the data to be used by the control programs. Since the main memory and the auxiliary memory are similar to those of the storage 102, detailed description thereof will be omitted.

The communication unit 203 is a communication interface for connecting the server apparatus 20 to the network. The communication unit 203 includes, for example, a network interface board or a radio communication circuit for radio communication.

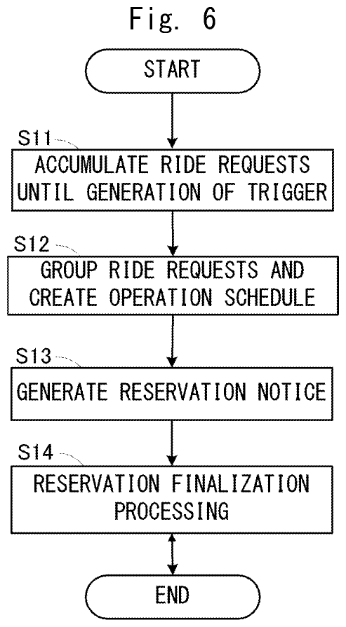

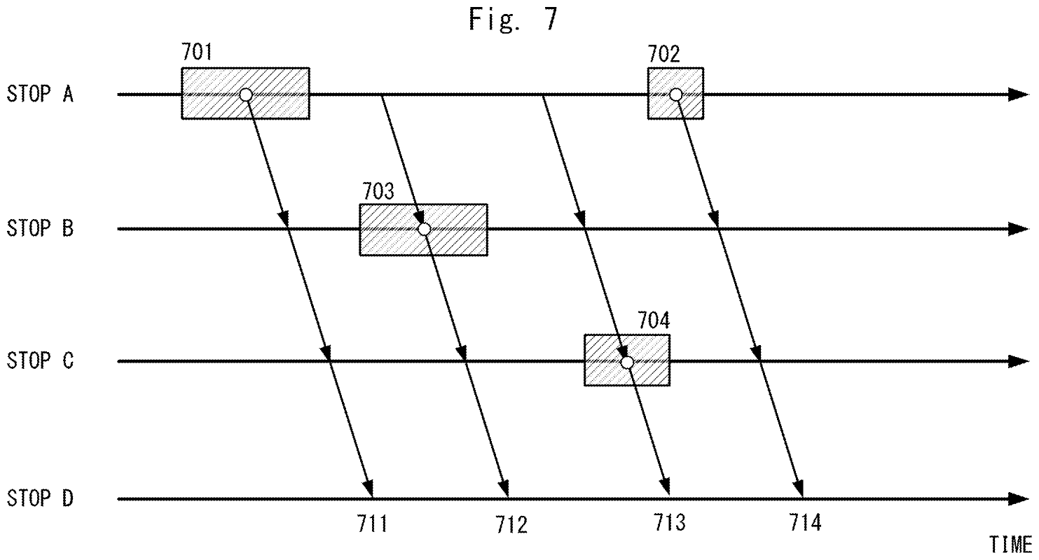

Next, details of the processing performed by the controller 201 will be described with reference to the flowchart illustrated in FIG. 6. The illustrated processing is executed with a predetermined period.

First, in step S11, the ride request acquisition unit 2011 acquires ride requests from a plurality of user terminals 10. Each user terminal 10 can transmit a ride request by, for example, a predetermined deadline time (for example, 30 minutes before a desired boarding time).

The acquired ride requests are accumulated until generation of a predetermined trigger. The trigger may be generated periodically (for example, every half hour) or may be generated at a predetermined time.

Upon generation of the predetermined trigger, the processing transitions to step S12.

In step S12, the vehicle dispatch plan creation unit 2012 (1) executes processing of grouping the plurality of ride requests, (2) determines arrival times of vehicles for the groups and (3) creates an operation schedule of the vehicles.

Description will be given with reference to FIG. 7. Here, it is assumed that vehicles travel in the order of stops A, B, C and D. Also, each of the hatched ranges represents a group including a plurality of ride requests whose desired boarding times fall within the relevant range.

First, the vehicle dispatch plan creation unit 2012 performs processing of selecting one or more ride requests to be grouped. This processing is executed for each boarding spot (stop). Here, it is assumed that: for stop A, group 701 and group 702 are created; for stop B, a group 703 is created; and for stop C, a group 704 is created.

Next, according to a predetermined rule, arrival times of vehicles for the groups are determined. Each of the white circles in the figure indicates an arrival time.

Subsequently, the vehicle dispatch plan creation unit 2012 creates an operation schedule of the vehicles. Since the arrival times of the vehicles for each stop are determined by the above-described processing, the operation schedule of the vehicles is created in such a manner that the vehicles arrive at the relevant stops at the respective arrival times. In the illustrated example, an operation schedule of four vehicles, which is indicated by reference numerals 711 to 714, is created.

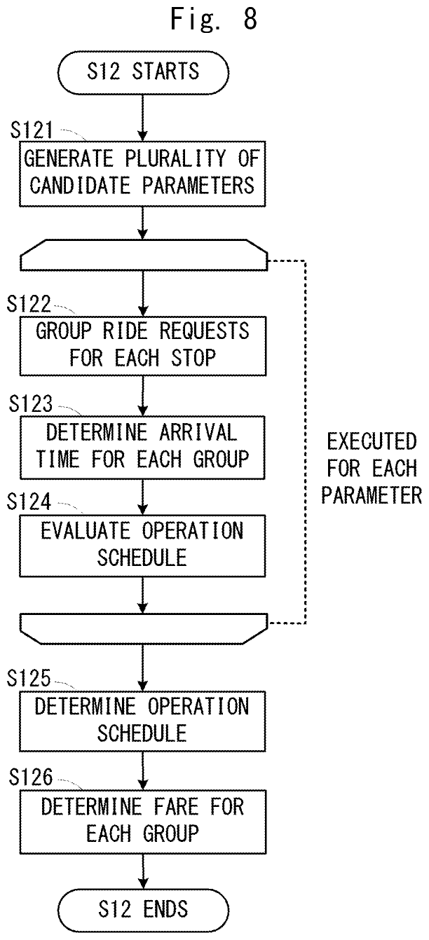

Here, the processing performed in step S12 will be described in more detail with reference to FIG. 8.

In the present step, the plurality of ride requests is grouped by a predetermined method. For the predetermined method, typically, a clustering method such as k-means may be employed; however, any method may be employed as long as such method enables grouping a plurality of values. In a case where a clustering method is employed for the grouping, for example, a density-based clustering method can be employed.

Also, where a method other than clustering is used, groups can be created in such a manner as to meet a predetermined condition. Examples of the predetermined condition can include “group a plurality of ride requests whose desired boarding times fall within in a predetermined time range (for example, 30 minutes)”.

The grouping processing can be performed using a predetermined parameter.

For example, where density-based clustering is performed, a parameter designating a density can be used. Also, where a plurality of ride requests whose desired boarding times fall within a predetermined time range is simply grouped, a parameter designating the time range can be used.

A result of the grouping can change depending on the parameter used. Also, as the result of the grouping changes, the operation schedule of the vehicles can also change. Therefore, in the present embodiment, a plurality of parameters to be used for grouping is generated and different patterns of groups are created for the respective parameters. Then, a plurality of operation schedules created for the respective patterns is evaluated and which pattern to be finally employed is determined.

In step S121, a plurality of candidate parameters to be used for grouping is generated.

In step S122, using one of the generated parameters, one or more ride requests are grouped for each stop.

Then, in step S123, arrival times for the respective groups are determined. An arrival time for a group can be determined, for example, by any of the following methods.

### (1) Value Intermediate Between an Earliest Desired Boarding Time and a Latest Desired Boarding Time

A method in which where T₁ is an earliest desired boarding time and T₂ is a latest desired boarding time, an arrival time is determined as

T_{arrival time}−(T₁+T₂)/2.

### (2) Weighted Average of Desired Boarding Times Calculated Using the Number of Users

A method in which where there are U₁ . . . Uₙ users who wish to board a vehicle at times T₁ . . . Tₙ, respectively, an arrival time is determined as

T_{arrival time}=(T₁U₁+T₂U₂+ . . . +TₙUₙ)/(U₁+U₂+ . . . +Uₙ).

For example, where three users, two users and one user wish to board a vehicle at 16:40, 17:00 and 17:15, respectively, an arrival time is 16:52.

(3) Desired Boarding Time with Largest Number of Users

A method in a desired boarding time with a largest number of users is determined as an arrival time.

Other methods can be employed. For example, a latest desired boarding time from among a group of ride requests may be determined as an arrival time.

Next, in step S124, an operation schedule of vehicles is created based on the determined groups and evaluated. For example, costs where vehicles operate according to the operation schedule illustrated in FIG. 7 are calculated. The costs include an operation cost of the vehicles and a cost borne by the users (hereinafter, “user cost”). The user cost may be, for example, a value that is a cumulative total of respective differences between a desired boarding time and the arrival time for the users.

The processing in steps S122 to S124 is executed for each of the plurality of parameters generated in step S121.

In step S125, a pattern to be finally employed is determined based on evaluation results acquired for the respective parameters. For example, a pattern whose cumulative total of costs is smallest may be selected.

Also, in the present step, a pattern not meeting a predetermined condition may be excluded. For example, a pattern that falls under any of the conditions below may be excluded:

(1) Case where there is a user whose difference between the relevant desired boarding time and the arrival time is equal to or exceeds a predetermined value (the predetermined value may be a fixed value or a value set for each user);
(2) Case where the user cost exceeds a predetermined value; and
(3) Case where the number of users exceeds a capacity of the vehicle.

Other conditions can be employed.

According to the above processing, an operation schedule of vehicles is determined.

Next, in step S126, fares for the respective groups are determined. The fares for the vehicles can be determined, for example, based on the number of users boarding a same vehicle at a same stop or the total number of users riding in a same vehicle.

For example, when a cost for one operation is 3000 yen and six users board a vehicle at a same stop, a fare per user can be set as 500 yen or more. Note that when a fare for a vehicle is determined based on the total number of users riding in the vehicle, the fare may be adjusted according to the distances of the rides. In either of the cases, as the number of users boarding a same vehicle at a same stop or the total number of users riding in a same vehicle is larger, a fare per user becomes lower. The fares for the vehicles may be calculated based on an expression or a table stored in advance.

With reference back to FIG. 6, the description will be continued.

Upon the operation schedule being determined, in step S13, the vehicle dispatch plan creation unit 2012 generates notification data. The notification data is data for notifying the users of the determined arrival times and the fares.

The notification data is transmitted to the user terminals 10, and when the users approve the notification data, the ride reservations are finalized (step S14). Also, based on the finalized ride reservations, the server apparatus 20 dispatches vehicles. For example, when vehicles are manually driven vehicles, the server apparatus 20 generate data for notifying drivers of respective operation times. Also, when the vehicles are autonomous vehicles, the server apparatus 20 generates instructions for travel of the vehicles.

Also, the server apparatus 20 transmits operation information of the vehicles to the respective user terminals 10. The operation information is provided to each user via the relevant guiding unit 1012.

As described above, where there is a plurality of users who wishes to board a vehicle at a same stop, the traffic system according to the first embodiment groups the plurality of users and determines an arrival time of a vehicle at the stop. Such configuration enables reduction in vehicle operation cost to the extent that convenience for users is not hindered.

### Alterations of First Embodiment

Although in the first embodiment, in step S11, ride requests are accumulated until a predetermined trigger is generated, when a user wishes, a group may be determined immediately without the processing in steps S121 to S124 being performed. In this case, when only one user belongs to a group, a fare is high in comparison with a case where a plurality of users board a vehicle at a same time; however, the user can reliably board a vehicle at a desired time.

Also, in the first embodiment, in step S14, the users are asked to determine whether or not to approve the notification data, when the users do not approve the notification data, the relevant ride requests may be brought into a waiting state again and grouping may be tried again. Consequently, it is possible to respond to, for example, a desire to “wait until more users join, because the fare is high”.

### Second Embodiment

In the traffic system according to the first embodiment, there may be cases where after groups are created, a ride request is transmitted from a new user. However, it is not realistic to reconstruct a group each time.

In order to respond to this case, the second embodiment is an embodiment in which a new ride request is accepted after a group is created.

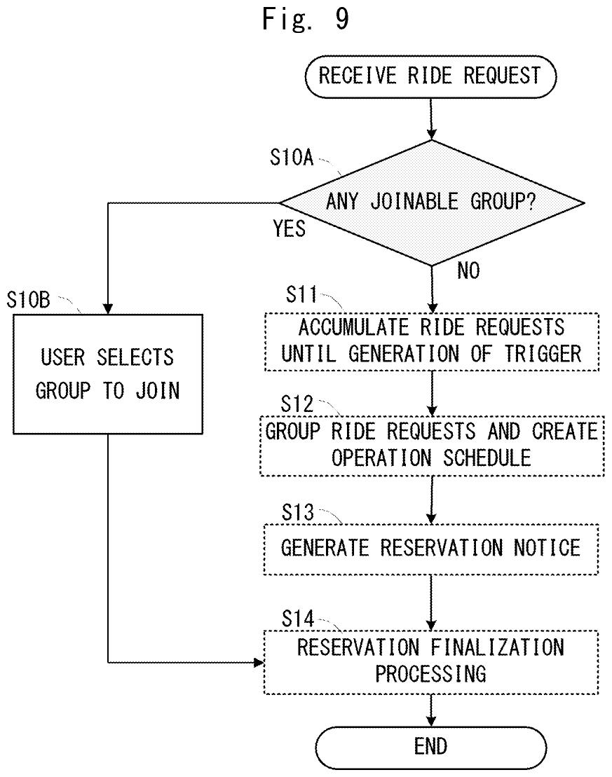

FIG. 9 is a flowchart of processing executed by a server apparatus 20 in the second embodiment.

In the second embodiment, when a ride request is received from a user terminal 10, whether or not there is a joinable group, more specifically, a group meeting the below conditions is determined in step S10A:

(1) Group for a boarding spot (stop) included in the ride request; and
(2) Group, a difference between an arrival time for the group and a desired boarding time included in the ride request being equal to or below a predetermined value.

When there is a group meeting the conditions, the processing transitions to step S10B.

In step S10B, data for asking whether or not to join the group (when there is a plurality of groups, which group to join) is transmitted to the user terminal 10 and the user's selection is acquired. The data includes an arrival time and a fare of a vehicle for each group. Then, based on the user's selection, a reservation is finalized in step S14.

Presenting an arrival time and a fare for each group enables providing options such as a “group that is low in fare but needs the user to wait” and a “group that is high in fare but enables the user to board a vehicle immediately” to the user.

Note that in step S10B, instead of selecting a group to join, an option “create a new group” may be provided to the user. When the user wishes to create a new group, a new group including the user only can be created. In this case, since only one user belongs to the group, a fare is high in comparison with a case where a plurality of users rides in a vehicle at a same time; however, the user can reliably board a vehicle at a desired time.

In step S10A, when there is no group meeting the conditions, the processing transitions to step S11. In other words, as in the first embodiment, a group is made after waiting for a trigger to occur. Note that as in an alteration of the first embodiment, when a user wishes, a group can be determined immediately without the processing in steps S121 to S124 being performed.

The second embodiment enables a new ride request to be accepted even in a state in which groups have already been made.

(Alternations)

Each of the above-described embodiments is definitely an example and the present disclosure can be implemented with appropriate changes made thereto without departing from the spirit thereof.

For example, the processes and measures described in the present disclosure can freely be combined as long as such combination causes no technical contraction.

Also, in the description of the embodiments, it is assumed that there is one route of on-demand buses; however, where there are a plurality of routes and operation directions (inbound and outbound), users whose destinations or directions are the same (that is, it is beneficial to users in riding a same vehicle) may be grouped.

Also, processing described as being performed by a single apparatus may be shared by a plurality of apparatuses. Alternatively, processes described as being performed by different apparatuses may be performed by a single apparatus. In a computer system, what hardware configuration (server configuration) to be employed to implement the respective functions can flexibly be changed.

The present disclosure can be implemented by supplying computer programs for implementing the functions described in the above embodiments to a computer and making one or more processors included in the computer read and execute the programs. Such computer programs may be provided to the computer via a non-transitory computer-readable storage medium that is connectable to a system bus of the computer or may be provided to the computer via a network. Examples of the non-transitory computer-readable storage medium include any types of disks such as a magnetic disk (e.g., a floppy (registered trademark) disk or a hard disk drive (HDD)) and an optical disk (e.g., a CD-ROM, a DVD disk or a Blu-ray disk) and any types of mediums suitable for storing electronic commands, such as a read-only memory (ROM), a random-access memory (RAM), an EPROM, an EEPROM, a magnetic card, a flash memory and an optical card.

What is claimed is:

1. An information processing apparatus for determining an operation schedule of a vehicle for a plurality of users to share a ride in, the information processing apparatus comprising a controller including at least one processor configured to execute:
first processing of acquiring one or more ride requests including a desired boarding time from each of one or more users wishing to board the vehicle at a predetermined boarding spot; and
second processing of grouping the one or more ride requests to create one or more groups and determining an arrival time of the vehicle at the boarding spot for each of the created groups.

2. The information processing apparatus according to claim 1, wherein the controller groups the ride requests based on a density of the desired boarding times relative to a time axis.

3. The information processing apparatus according to claim 1, wherein the controller determines the arrival time for each group in such a manner that a difference between the desired boarding time and the arrival time is equal to or below a predetermined value for all of the users.

4. The information processing apparatus according to claim 1, wherein the controller calculates a weighted average of the desired boarding times using number of the users for each of the created groups, and based on a result of the calculation, determines the arrival times for the respective groups.

5. The information processing apparatus according to claim 1, wherein for each of the created groups, the controller calculates a fare of the vehicle for the relevant users based on number of the ride requests included in the group.

6. The information processing apparatus according to claim 5, wherein for each of the created groups, the controller makes the fare for the relevant users lower as the number of the ride requests included in the group is larger.

7. The information processing apparatus according to claim 5, wherein after completion of the grouping, the controller presents the calculated fares to the users and finalizes reservations.

8. The information processing apparatus according to claim 5, wherein when there are joinable groups already created at a phase of acquisition of the ride requests from the users, the controller makes the users select which group to join.

9. The information processing apparatus according to claim 5, wherein when there are joinable groups already created at a phase of acquisition of the ride requests from the users, the controller makes the users select which group to join or select whether or not to create a new group.

10. The information processing apparatus according to claim 8, wherein the controller makes the users make the selection after calculating the fare for each group and presenting the fares to the users.

11. An information processing method for determining an operation schedule of a vehicle for a plurality of users to share a ride in, the information processing method comprising:
acquiring one or more ride requests including a desired boarding time from each of one or more users wishing to board the vehicle at a predetermined boarding spot; and
grouping the one or more ride requests to create one or more groups and determining an arrival time of the vehicle at the boarding spot for each of the created groups.

12. The information processing method according to claim 11, wherein the ride requests are grouped based on a density of the desired boarding times relative to a time axis.

13. The information processing method according to claim 11, wherein the arrival time for each group is determined in such a manner that a difference between the desired boarding time and the arrival time is equal to or below a predetermined value for all of the users.

14. The information processing method according to claim 11, wherein, a weighted average of the desired boarding times is calculated using number of the users for each of the created groups, and based on a result of the calculation, the arrival times are determined for the respective groups.

15. The information processing method according to claim 11, wherein, for each of the created groups, a fare of the vehicle for the relevant users is calculated based on number of the ride requests included in the group.

16. The information processing method according to claim 15, wherein, for each of the created groups, the fare for the relevant users is made to be lower as the number of the ride requests included in the group is larger.

17. The information processing method according to claim 15, wherein, after completion of the grouping, the calculated fares are presented to the users and reservations are finalized.

18. The information processing method according to claim 15, wherein, when there are joinable groups already created at a phase of acquisition of the ride requests from the users, the users are made to select which group to join.

19. The information processing method according to claim 18, wherein the users are made to make the selection after calculating the fare for each group and presenting the fares to the users.

20. A non-transitory storage medium storing a program for making a computer execute the information processing method according to claim 11.
